(19) United States
(12) Patent Application Publication
(10) Pub. No.: US 2014/0379201 A1
(43) Pub. Date: Dec. 25, 2014

(54) APPARATUS AND METHOD FOR VEHICULAR SELF-DIAGNOSIS

(71) Applicant: DENSO CORPORATION, Kariya-city (JP)

(72) Inventors: Shingo Wanami, Kariya-city (JP); Shigenori Kobayashi, Hazu-gun (JP)

(21) Appl. No.: 14/306,589

(22) Filed: Jun. 17, 2014

(30) Foreign Application Priority Data
Jun. 20, 2013 (JP) 2013-129104

(51) Int. Cl. G07C 5/08

(52) U.S. Cl. CPC G07C 5/0808
USPC 701/29.7

(57) ABSTRACT

A vehicular self-diagnosis apparatus in a vehicle diagnoses whether a sensor serving as an accessory in the vehicle exhibits an anomaly. The apparatus includes a state recording section and a determination recording section. The state recording section records sensor information of the sensor. The determination recording section determines a normal state, a failed state, or a non-normal state, whichever the sensor exhibits based on the sensor information, and records the determined state. This reduces useless inspection or repair of the sensor having exhibited the non-normal state that is enabled to return to the normal state.

### CROSS REFERENCE TO RELATED APPLICATION

The present application is based on Japanese Patent Application No. 2013-129104 filed on Jun. 20, 2013, the disclosure of which is incorporated herein by reference.

### TECHNICAL FIELD

The present disclosure relates to an apparatus and method for vehicular self-diagnosis to diagnose whether an accessory in a vehicle is anomalous.

### BACKGROUND ART

Patent Literature 1: JP 2006-088750 A

Patent Literature 1 discloses a vehicular information recording apparatus that records vehicle information to analyze an anomaly, which may be difficult to reproduce or determine accurately even if the vehicle is brought into and inspected by an auto garage or a car dealer. This vehicular information recording apparatus includes a manipulation portion a user manipulates. When the manipulation portion is manipulated, the vehicle information at that time is recorded in a recording portion.

However, in the above vehicular information recording apparatus, if the user does not manipulate the manipulation portion, any vehicle information is not recorded. Thus, even if the above vehicular information recording apparatus is adopted, there may be still present an issue where an anomaly is difficult to reproduce or determine accurately.

Meanwhile, there may be a case where an accessory in a vehicle becomes in inappropriate state and then returns to a normal state. Such a case may be referred to as a non-normal state or a transient anomalous state. This non-normal state, if happens, may be reported to the driver as a warning of an anomaly. When the accessory returns to a normal state, the warning may be stopped. Further, even if the vehicle is brought into and inspected by an auto garage or car dealer, such non-normal state may be difficult to reproduce or determine accurately.

### SUMMARY

It is an object of the present disclosure to provide a vehicular self-diagnosis apparatus that reduces useless inspection or repair of an accessory.

According to an example of the present disclosure, a vehicular self-diagnosis apparatus for a vehicle is provided to diagnose whether an accessory in the vehicle exhibits an anomaly. The apparatus includes a state recording section and a determination recording section. The state recording section records accessory data of the accessory. The determination recording section determines which state among a normal state, a failed state, and a non-normal state the accessory exhibits based on the accessory data, and records the determined state.

Such a configuration can distinguish the non-normal state from the normal state or failed state, thereby reducing useless inspection or repair of the accessory having exhibited the non-normal state that is enabled to return to the normal state.

According to another example of the present disclosure, a method is provided for controlling the above vehicular self-diagnosis apparatus.

This configuration also can distinguish the non-normal state from the normal state or failed state, thereby reducing useless inspection or repair of the accessory having exhibited the non-normal state that is enabled to return to the normal state.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a schematic diagram illustrating a configuration of a vehicular self-diagnosis apparatus according to a first embodiment of the present disclosure;

FIG. 2 is a schematic diagram illustrating connections of the self-diagnosis apparatus and sensors;

FIG. 3 is a flowchart diagram illustrating a diagnosis/inquiry process;

FIG. 4 is a diagram illustrating an example of inquiry about factors;

FIG. 5 is a diagram illustrating an example of advice of return to normal;

FIG. 6 is a diagram illustrating an example of time-based change of detection value of accessory; and

FIG. 7 is a diagram illustrating a schematic plan view of an example of components of an accessory while indicating an example of a non-normal state.

### DETAILED DESCRIPTION

### First Embodiment

A vehicular self-diagnosis apparatus 20 in a vehicle 10 according to a first embodiment of the present disclosure will be explained with reference to drawings.

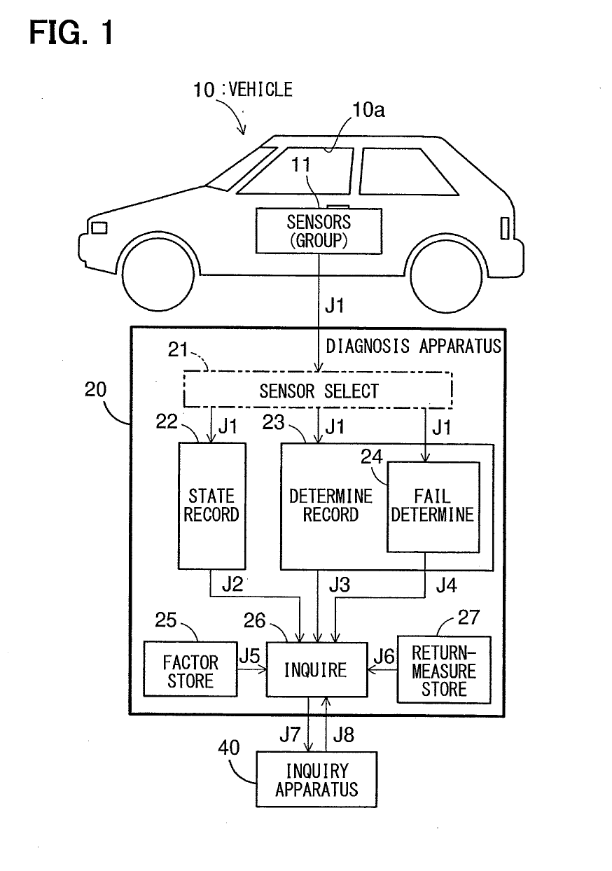

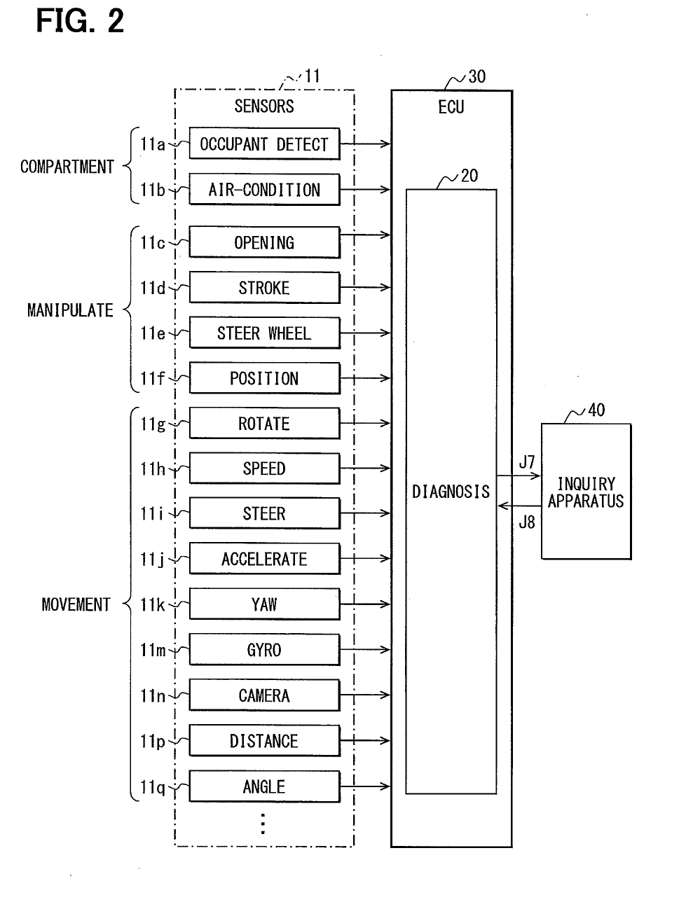

With reference to FIG. 1, the vehicle 10 is provided with the self-diagnosis apparatus 20, sensors 11 (sensor group), and an inquiry apparatus 40. Each sensor 11 may be also referred to as an accessory in the vehicle 10. The sensors 11 include a sensor that detects an air-conditioning state in a vehicle compartment 10a, a sensor that detects a manipulation state by a driver of the vehicle 10, and a sensor that detects a movement state of the vehicle 10. The sensors 11 will be explained later in detail with reference to FIG. 2.

With reference to FIG. 1, the self-diagnosis apparatus 20 includes a sensor selecting section 21, a state recording section 22, a determination recording section 23, a factor storage portion 25, an inquiring section 26, and a return-measure storage portion 27. The sensor selecting section 21 may be eliminated from the self-diagnosis apparatus 20 as needed. The apparatus 20 may be included in an ECU (Electronic Control Unit).

The sensor selecting section 21 switched the sensors 11 to select in order one of the sensors 11 as a target of self-diagnosis during self-diagnosis. The state recording section 22 records sensor information J1, which is also referred to as accessory data, with respect to the respective sensors 11. The determination recording section 23 determines one of a normal state, a failed state, and a non-normal state the sensor 11 exhibits, based on the sensor information J1, and records the determined state of the sensor 11. The determination recording section 23 may include a failure determination portion 24 that determines whether the sensor 11 is failed. The factor storage portion 25 stores at least one factor with respect to each of the sensors 11; the factor leads each sensor 11 to a non-normal state. The return-measure storage portion 27 stores at least one return measure with respect to the sensor 11 that exhibits a non-normal state; the return measure permits the sensor 11 to return from the non-normal state to the normal state.

The inquiring section 26 conducts an inquiry via the inquiry apparatus 40 based on the sensor information J2 recorded in the state recording section 22, and determined state information J3 determined in the determination recording section 23 (including the determined failure information J4). The inquiry contains the factor information J5 stored in the factor storage portion 25, or the return measure information J6 stored in the return-measure storage portion 27.

The inquiry apparatus 40 includes a notification apparatus or an input apparatus that achieves an inquiry. The notification apparatus corresponds to a display apparatus or an audio apparatus. The notification apparatus may be an existing apparatus such as a navigation apparatus, a center console. The input apparatus corresponds to a switch or a touch panel. The input apparatus may be a switch or a touch panel of an apparatus (e.g., air-conditioner, audio apparatus, or navigation apparatus) assembled into a steering wheel or dashboard. The inquiry apparatus 40 conducts an inquiry based on the inquiry information J7 (including the factor information J5 or the return-measure information J6), which is transmitted from the inquiring section 26; the inquiry apparatus 40 transmits a response to the inquiry as the response information J8 to the inquiring section 26.

The state recording section 22 and the determination recording section 23 use storage media to record data. Further, the factor storage portion 25 and the return-measure storage portion 27 use storage media to store data. Such storage media may use a flash memory including SSD (Solid State Drive), a hard disk, an optical disk including magnetic optical disk, a flexible disk, a RAM, or a ROM. It is desirable to use a nonvolatile memory to hold recorded or stored data even after the electric power supply is interrupted. Further, in the following explanation, recording or storing naturally signifies recording or storing data in storage media.

FIG. 2 illustrates an example configuration to provide an ECU 30; the ECU 30 includes the self-diagnosis apparatus 20 and is connected with the sensors 11 and inquiry apparatus 40. The ECU 30 may have a configuration where a CPU executes processing based on software programs or a configuration where a hardware logic executes processing. It is noted that “connect” or “connection” in the present description may signify “electrically connect” or “electrical connection.”

The example configuration in FIG. 2 includes a single ECU for simplifying explanation; alternatively, the self-diagnosis apparatus 20 can be provided by a plurality of ECUs that execute distributed processing for respective purposes. The ECUs may include a sensor ECU that manages the sensors 11; a drive ECU that controls drives such as engine, motor; a battery ECU that manages a battery; and an occupant protection ECU that protects an occupant by inflating an airbag. When the plurality of ECUs are provided, a main ECU may be desirably provided to manage the whole of the ECUs comprehensively.

The following explains examples of the sensors 11 or sensor group that is connected to the ECU 30 with reference to FIG. 2. Three sub-groups of sensors are included: a compartment sub-group; a manipulation sub-group; and a movement or travel sub-group. The compartment sub-group includes an occupant detection sensor 11a and an air-conditioner sensor 11b. The manipulation sub-group includes an opening sensor 11c, a stroke sensor 11d, a steering-wheel angle sensor 11e, and a position sensor 11f. The movement sub-group includes a rotation sensor 11g, a speed sensor 11h, a steering angle sensor 11i, an acceleration sensor 11j, a yaw rate sensor 11k, a gyroscope 11m, a camera 11n, a distance sensor 11p, and an angle sensor 11q. The sensors 11 have respective functions; another sensor that has the same function may be alternatively adopted. Each sensor outputs a signal that includes sensor information J1.

The occupant detection sensor 11a detects and outputs a seating state of an occupant against a seat such as a presence or absence of an occupant, physical size. The air-conditioner sensor 11b detects and output an air-conditioning state of a compartment 10a of the vehicle 10; the air-conditioning state includes at least one of a temperature, a humidity, a solar isolation, and a temperature of an occupant, which correspond to a temperature sensor, a humidity sensor, a solar isolation sensor, and a thermography sensor, respectively.

The opening sensor 11c detects and outputs an opening of an accelerator varying depending on the driver's manipulating the accelerator pedal. The stroke sensor 11d is provided to each of at least one of a foot brake pedal, a parking brake pedal, and a crutch pedal, to detect and output a stroke amount varying depending on the driver's manipulating each pedal. The steering-wheel angle sensor 11e detects and outputs a steering-wheel angle varying depending on the driver's manipulating the steering wheel. The position sensor 11f detects and outputs a position (i.e., gear or range) due to a shift manipulation to a shift lever or select lever.

The rotation sensor 11g detects and outputs a rotation number of a power source such as engine, motor. The speed sensor 11h detects and outputs a speed of the vehicle 10 such as a speed based on the rotation speed of the wheel. The steering angle sensor 11i detects and outputs a steering angle of the vehicle 10 (i.e., wheel). The acceleration sensor 11j detects and outputs an acceleration of the vehicle 10 such as an acceleration based on the rotation speed of the wheel. The yaw rate sensor 11k detects and outputs a yaw rate of the vehicle 10. The gyroscope 11m detects and outputs an angular speed including a rotation angle of the vehicle 10. The camera 11n captures images or videos of scenery outside and inside of the vehicle 10. The distance sensor 11p detects and outputs a relative distance between the vehicle 10 and an object such as an inter-vehicle distance. The object includes any object other than the vehicle 10 such as: a different vehicle; a structure including an architecture construction; an installation including a traffic board, a traffic signal, or a guard rail; an animal including a human being. The relative distance may be measured in various detection manners such as detection by transmitting and receiving detection waves such as light, radio, sound wave; detection by analyzing the image captured by the camera 11n. The angel sensor 11q detects and outputs an angle of the vehicle 10 such as an inclination angle of a roll angle or a pitch angle. The roll angle teaches an inclination angle of a road (i.e., bank); the pitch angle teaches forward tilting or backward tilting.

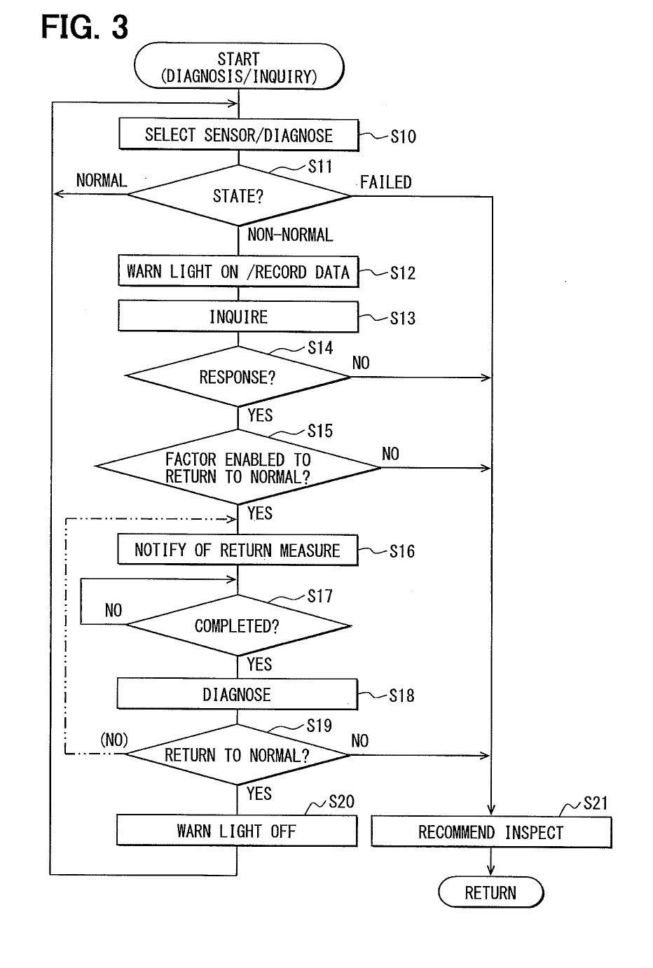

The following explains an example of a diagnosis/inquiry process executed by the self-diagnosis apparatus 20 with reference to FIG. 3.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

For instance, S10 may be provided as a sensor selecting section 21. S11 and S12 may be provided as a determination recording section 23 that may include a failure determination portion 24. S10 or S12 may be provided as a state recording section 22. S13 or S16 may be provided as an inquiring section 26.

The diagnosis/inquiry process in FIG. 3 is repeatedly executed while a power is supplied by a power source (unshown). At S10, a self-diagnosis of the vehicle 10 is executed. The self-diagnosis is executed while one of the sensors 11 is selected in series. Thereby, sensor information J1 is acquired with respect to each of the sensors 11. To know the state before changing to the failed state or non-normal state, an initially acquired sensor information J1 may be recorded as initial accessory data.

At S11, an operating state of each sensor 11 is determined based on the result of the self-diagnosis at S10. For instance, it is determined whether the sensor information J1 with respect to each sensor 11 is within a normal range.

When the determination recording section 23 determines that all the sensors 11 are in normal state (or exhibit normal state), any inquiry or any inspection is unnecessary. The processing returns to S10 to repeat self-diagnosis. In contrast, when the failure determination portion 24 determines that at least one sensor 11 is in a failed state, an inspection or repair is recommended at S21. The process is then returned. At S21, a warn light pertinent to the sensor 11 in the failed state may be turned on or blinked to indicate which sensor 11 is in the failed state. The warn light may be typically installed in an instrument panel, or in any position inside of the compartment of the vehicle 10 such as a center console or dashboard.

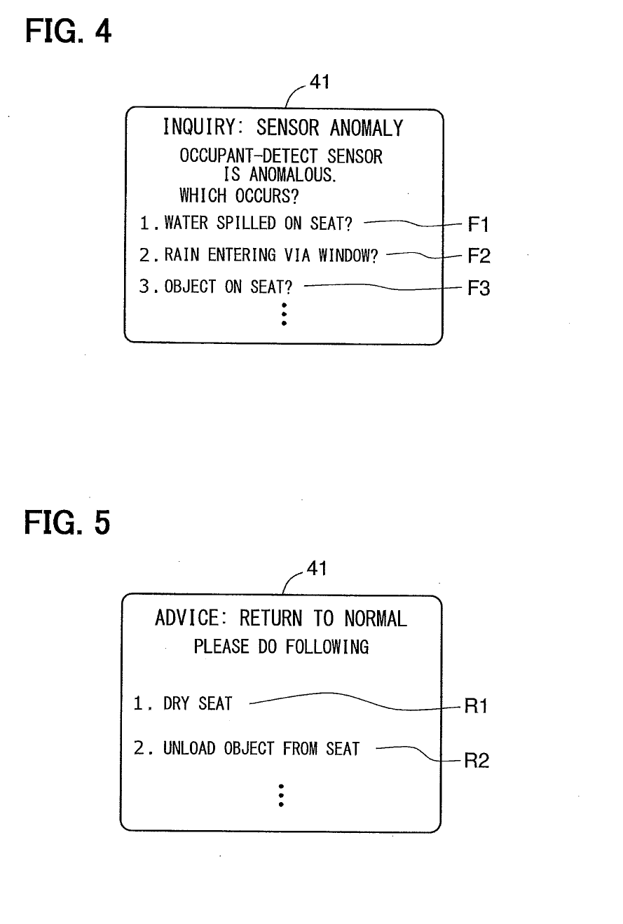

In contrast, when the determination recording section 23 determines that the sensor 11 is in the non-normal state and, simultaneously, the failure determination portion 24 determines that the sensor 11 is not in the failed state, the processing proceeds to S12. At S12, a corresponding warn light is turned on and the sensor information J1 is acquired and recorded as an accessory data. The non-normal state is a state where the sensor 11 is inappropriate to operate. In other words, the sensor 11 itself is operating or operable so that it is not determined to be in the failed state; the sensor information J1 is determined to be outside of the normal range. At S13, an inquiry with respect to the sensor 11 that exhibits the non-normal state is conducted via the inquiry apparatus 40. FIG. 4 illustrates an example of an inquiry or an inquiry window in a display device 41 of the inquiry apparatus 40. The display device 41 displays factors F1, F2, F3, . . . that leads the sensor 11 to the non-normal state. At S14, it is determined whether a response to the inquiry is received from the occupant. When any response is not received (S14: NO), an inspection or repair is recommended at S21. The process is then returned.

In contrast, when a response to the inquiry is received (S14: YES), the processing proceeds to S15. Even when an operator, regardless of the occupant of the vehicle 10, conducts any return work, a non-normal state is not returned to the normal state depending on factors. The relation between a return measure and a return possibility or probability may be recorded (learnt or accumulated) using storage media. At S15, it is determined whether any return measure corresponding to the factor is enabled to return the non-normal state to the normal state. When it is determined that any return measure is not enabled to return the non-normal state to the normal state (S15: NO), an inspection or repair is recommended at S21. The process is then returned.

In contrast, when it is determined that a return measure is enabled to return the non-normal state to the normal state (S15: YES), the processing proceeds to S16. At S16, a solution or return measure that returns the sensor 11 from the non-normal state to the normal state is notified. The processing stands by until the return measure is completed (S17: NO). FIG. 5 illustrates an example of the notification at S16 using the inquiry apparatus 40. The example contains a recommendation or a return measure that returns the sensor 11 from the non-normal state to the normal state. As illustrated in FIG. 5, the display device 41 displays return measures R1, R2, . . . . The return measures may be listed in an order from the return measure having a highest possibility of returning to the normal state; they may be displayed using images or videos. Further, the images or videos may be accompanied by sounds or voices for explanation.

At S17, it is determined whether the return work for the return measure is completed based on input from an input apparatus. When it is determined that the return work is completed (S17: YES), the processing proceeds to S18, where a self-diagnosis is conducted. Conducting the self-diagnosis at S18 may be trigger by a manual input by an occupant from the input apparatus. In such a case triggered by a manual input, if an input is not received for a predetermined time period (e.g., five minutes or one hour), the self-diagnosis may be started automatically. The self-diagnosis at S18 may be applied to the sensor 11 having exhibited the non-normal state or all the sensors 11.

When the sensor 11 is determined to have returned to the normal state (S19: YES), the processing proceeds to S20, where the warn light that was turned on at S12 is turned off. The processing then returns to S10 to repeat the self-diagnosis. At S20, for the purpose of comparison between the non-normal state and the normal state, the sensor information J1 of the sensor 11 having returned to the normal state may be recorded as the accessory data.

In contrast, when the sensor 11 is determined to have not returned to the normal state (S19: NO), the processing proceeds to S21, where an inspection or repair is recommended. The processing then is returned. Further, to provide another chance to try another return measure, the processing may be returned to S16 as indicated by an alternate long and short dash line. This enables another notification of a different return measure to return the sensor 11 from the non-normal state to the normal state, and another self-diagnosis after the return work corresponding to the different return measure is completed (S16 to S19).

Further, the inquiry at S13, the response at S14, the notification at S16, the response of completion at 517, and the like may be recorded as history or process history. That is, the history includes what a kind of response is received with respect to the factors F1, F2, F3, . . . , and whether the response of completion is received against the notification relative to the return measures R1, R2, . . . . Analyzing of the recorded history can facilitate the investigation of the states of the sensor 11 or the investigation of causes of anomaly.

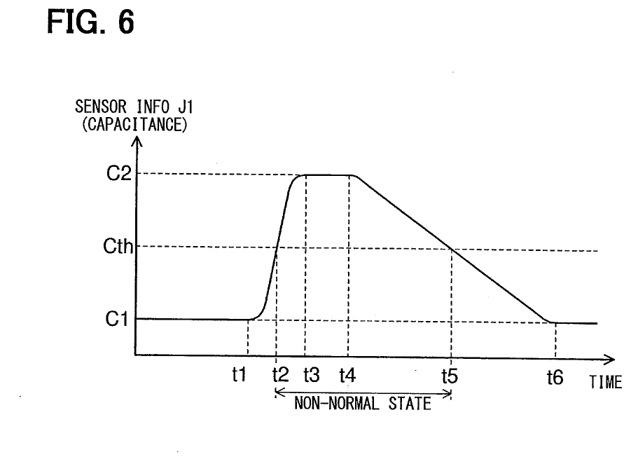

The following will explain the diagnosis/inquiry process on the assumption that the occupant detection sensor 11a is represented as the sensors 11 with reference to FIG. 6. The occupant detection sensor 11a is provided in a seat to use an electrostatic capacitance that varies depending on water included in a human body. A normal range of a capacitance is designated to be a range of the variation depending on human bodies. The detected capacitance by the occupant detection sensor 11a naturally also varies depending on the water other than the human bodies. When the seat is splashed or wet with water, the sensor 11a detects a capacitance in a range different from that of the human bodies, namely, outside of the normal range of the human bodies. This different range due to the water other than the human bodies may be designated to be a non-normal range corresponding to the non-normal state.

With reference to FIG. 6, the capacitance threshold value Cth is an example of a reference value to determine whether the occupant detection sensor 11a is in the normal state or in the non-normal state. When the sensor 11a is failed, the sensor 11a can detect a very small amount of capacitance or cannot detect a capacitance itself; thus, the failure of the sensor 11a is unrelated to the capacitance threshold value Cth.

In FIG. 6, the sensor 11a detects a capacitance C1 that is lower than the capacitance threshold value Cth until time t1. Thus, the sensor 11a is determined to be in the normal state until the time t1 (S11).

At the time t1, some factor arises; for instance, the seat may be wet or splashed with water. The detected capacitance changes from the time t1. At the time t2, the detected capacitance reaches the capacitance threshold value Cth; further, at the time t3, the detected capacitance reaches a capacitance C2. Thus, the sensor 11a is determined to be in the non-normal state at the time t2 (S11); an inquiry is conducted about the factors F1, F2, F3, . . . (S14). Further, upon receiving a response, the return measures R1, R2, . . . that return the sensor 11a to the normal state are notified (S16).

The detected capacitance starts decreasing from the time t4 when an operator starts conducing the return work corresponding to the return measure R1, R2, . . . according to the notification. The detected capacitance further decreases to the capacitance threshold value Cth at the time t5, and returns to the capacitance C1 at the time t6. Thus, the sensor 11a is determined to be in the non-normal state until the time t5; then, the sensor 11a is determined to be in the normal state after the time t5 (S18, S19).

The above first embodiment provides the following advantageous effects.

(1) The vehicular self-diagnosis apparatus 20 includes the state recording section 22 to repeatedly record the sensor information J1 (accessory data) of the sensor 11 (accessory); and the determination recording section 23 to determine a normal state, a failed state, or a non-normal state, whichever the sensor 11 exhibits based on the sensor information J1, and record the determined state (see FIGS. 1 and 3). Such a configuration can reduce useless inspection or repair of the sensor 11 having exhibited the non-normal state that can return to the normal state.

(2) The vehicular self-diagnosis apparatus 20 further includes the factor storage portion 25 to store at least one factor F1, F2, F3, . . . with respect to the sensor 11; the factor F1, F2, F3, . . . causes the sensor 11 to transition from the normal state to the non-normal state; and the inquiring section 26 to conduct an inquiry based on the factor F1, F2, F3, . . . when the determination recording section 23 determines that the sensor 11 exhibits the non-normal state (see FIGS. 3 and 4). Such a configuration conducts an inquiry aggressively, thereby reducing the situation where the anomaly cannot be reproduced or the factor or cause of the anomaly cannot be understood.

(3) The vehicular self-diagnosis apparatus 20 further includes the return-measure storage portion 27 to store at least one return measure R1, R2, . . . that returns the sensor 11 from the non-normal state to the normal state. The inquiring section 26 conducts the inquiry about the return measure R1, R2, . . . with respect to the sensor 11 exhibiting the non-normal state (FIGS. 3 and 5). Such a configuration notifies the return measures R1, R2, . . . aggressively, thereby enabling the sensor 11 in the non-normal state to return to the normal state easily. If the sensor 11 returns to the normal state, useless works such as an inspection or repair of the sensor 11 can be further reduced.

(4) The vehicular self-diagnosis apparatus 20 further includes the failure determination portion 24 to determine whether the sensor 11 is failed or in a failed state when the determination recording section 23 determines that the sensor 11 exhibits the non-normal state. The inquiring section 26 conducts the inquiry when the determination recording section 23 determines that the sensor 11 exhibits the non-normal state and, simultaneously the failure determination portion 24 determines that the sensor 11 is not failed (see FIGS. 1 and 2). Such a configuration clearly indicates that the sensor 11 is not failed so that the inquiry about the factors F1, F2, F3, . . . is conducted aggressively. This leads to the reduction of the situation where the anomaly cannot be reproduced or the factor or cause of the anomaly cannot be understood.

(5) In the vehicular self-diagnosis apparatus 20, the inquiring section 26 conducts the inquiry about at least one return measure R1, R2, . . . in an inquiry order from the return measure having a highest possibility of returning the sensor 11 from the non-normal state to the normal state (see FIGS. 3 and 5). Such a configuration facilitates the returning of the sensor 11 to the normal state, thereby reducing the useless return work.

(6) In the vehicular self-diagnosis apparatus 20, the inquiring section 26 conducts the inquiry about at least one return measure R1, R2, . . . by displaying at least one return measure R1, R2, . . . using an image or a video. Such a configuration facilitates the recognition of how to conduct a return work and makes the return work easier, thereby reducing useless time for the return work.

(7) In the vehicular self-diagnosis apparatus 20, in cases that a response of completion is received following the inquiring section's conducting the inquiry about the return measure R1, R2, . . . , the determination recording section 23 then determines whether the sensor 11 exhibits the normal state or the non-normal state (S16 to S18 in FIG. 3). Such a configuration determines whether the sensor 11 have returned to the normal state by the return work based on the return measure R1, R2, . . . ; thus, a subsequent measure may be known properly. That is, when having returned to the normal state, any inspection or repair is unnecessary. When not having returned to the normal state, a return work based on a different return measure may be conducted or an inspection or repair may be conducted. This reduces a useless inspection or repair.

(8) In the vehicular self-diagnosis apparatus 20, the inquiring section 26 records a history of an inquiry and a response (FIG. 3). Such a configuration facilitates understanding of the state of the sensor 11 and the investigation to determine the cause based on the recorded history.

(9) In the vehicular self-diagnosis apparatus 20, in cases that the determination recording section 23 still determines that the sensor 11 exhibits the non-normal state after the response of completion is received for each return measure R1, R2, . . . , the inquiring section 26 recommends an inspection or a repair of the sensor 11 that still exhibits the non-normal state (S17 to S19). Under such a configuration, even after an operator or occupant conducts a return work, the sensor 11 has not returned to the normal state; thus, there is a high possibility that the sensor 11 is failed. Recommending an inspection or repair reduces a waste effectively.

(10) In the vehicular self-diagnosis apparatus 20, the sensor 11 is explained as one example of an accessory in the vehicle 10 (FIGS. 1 and 2). The sensor 11 may be replaced by any other accessory in the vehicle 10.

(11) A method is provided for controlling the vehicular self-diagnosis apparatus 20 in the vehicle 10. The method includes a state recording step (S10, S12 in FIG. 3) of recording sensor information J1 (accessory data) of the sensor 11 (accessory) in a storage portion, and a determination recording step (S11, S12 in FIG. 3) of (i) determining a normal state, a failed state, and a non-normal state, whichever the sensor 11 exhibits based on the sensor information J1, and (ii) recording the determined state. Such a configuration can reduce useless inspection or repair of the sensor 11 having exhibited the non-normal state that can return to the normal state.

(12) The vehicular self-diagnosis apparatus 20 includes the factor storage portion 25 to store at least one factor F1, F2, F3, . . . with respect to the sensor 11, the factor leading the sensor 11 to the non-normal state. The method for controlling the vehicular self-diagnosis apparatus 20 further includes an inquiring step (S13) of conducting an inquiry based on the factor F1, F2, F3, . . . when it is determined that the sensor 11 exhibits the non-normal state in the determination recording step (S11). Such a configuration conducts an inquiry aggressively, thereby reducing the situation where the anomaly cannot be reproduced or the factor or cause of the anomaly cannot be understood.

(13) The vehicular self-diagnosis apparatus 20 further includes the return-measure storage portion 27 to store at least one return measure R1, R2, . . . that permits the sensor 11 to return from the non-normal state to the normal state. In the method for controlling the vehicular self-diagnosis apparatus 20, the inquiry about the return measure R1, R2, . . . is conducted with respect to the sensor 11 exhibiting the non-normal state. Such a configuration notifies the return measures R1, R2, . . . aggressively, thereby enabling the sensor 11 in the non-normal state to return to the normal state easily. If the sensor 11 returns to the normal state, useless works such as an inspection or repair of the sensor 11 can be further reduced.

### Other Embodiments

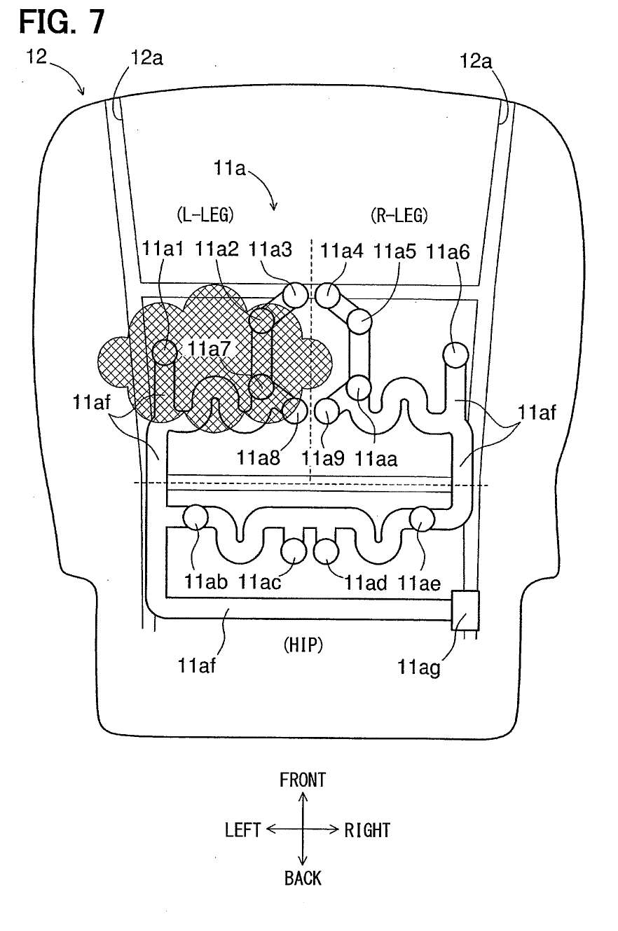

In the first embodiment, the occupant detection sensor 11a is designated as a representative example of the sensors 11. In this case, whether the occupant detection sensor 11a is in the normal state or in the non-normal state is determined based on the capacitance threshold value Cth. In contrast, the failed state is determined when the capacitance itself is not detected. The following configuration may be substituted or additionally provided. That is, suppose that the occupant detection sensor 11a includes a plurality of detection cells, which are classified into three regional groups of (i) the left leg region, (ii) the right leg region, and (iii) the hip region, as divided by the dotted lines in FIG. 7. The determination of the state among the normal state, the failed state, and the non-normal state is executed based on the sensor information J1 of the detection cells with respect to each regional group. FIG. 7 illustrates that a portion of the seat 12, which is shown by the cross-hatched pattern, is wet or splashed with water. In this case, the sensor information J1 of the detection cells in the left leg region exhibit the non-normal state; the sensor information J1 of the detection cells in the right leg region and the hip region exhibit the normal state. Such a configuration permits the determination that a part of the occupant detection sensor 11a is in the non-normal state while the remaining part of it is in the normal state. This facilitates the determination whether the sensor 11a is in the failed state. This further improve the accuracy of the normal state, the failed state, and the non-normal state. This may be also applied to some sensor 11 that has a plurality of detection cells.

In the first embodiment, the accessory includes the sensors 11 illustrated in FIG. 2. Another configuration may be substituted or additionally provided. That is, other than the sensors 11 in FIG. 2, another sensor or another component in the vehicle 10 may be provided as an accessory. For instance, another sensor may include an invasion sensor or an inclination sensor; another component may include a driving component such as an engine, motor, and a power component such as a secondary battery, solar battery, fuel battery. Such another sensor or another component naturally belongs to an accessory; if it is adopted, the same advantageous effect can be provided.

In the first embodiment, the self-diagnosis apparatus 20 is included in the ECU 30 as in FIG. 2. Alternatively, the self-diagnosis apparatus 20 may be provided inside of the vehicle 10 including another ECU other than the ECU 30 or outside of the vehicle 10. For instance, the self-diagnosis apparatus 20 may be installed in an external processing apparatus that communicates with the vehicle 10 via a communication line. This configuration is different from the first embodiment only in location; thus, the same advantageous effect may be provided.

In the first embodiment, the inquiry apparatus 40 includes the display device 41 (FIGS. 1, 4, and 5). Another notification apparatus may be substituted or additionally provided so as to achieve an inquiry of factors or a notice of return measures. That is, such a notification apparatus includes a speaker outputting a sound, or a portable terminal such as a cellular phone, a tablet terminal. The cellular phone may be mounted in the vehicle 10 or brought into the vehicle 10 by an occupant. The cellular phone may receive an inquiry or a notification of a return measure via a communication. That is, any apparatus may be sufficient which can conduct an inquiry or a notification of a return measure to an occupant in the vehicle 10. This configuration is the same as the first embodiment in inquiry or notification of a return measure; thus, the same advantageous effect may be provided.

In the first embodiment, the self-diagnosis apparatus 20 is mounted in the vehicle 10, but may be alternatively mounted in any transportation apparatus such as an airplane or ship, which carries a user or a cargo aboard. This configuration is different from the first embodiment in structure of transportation apparatus; the same advantageous effect may be provided.

Furthermore, the accessory may be any apparatus, device, component, or the like, which is provided in a vehicle. The normal state of an accessory is a state where the accessory operates normally. The failed state is a state where the accessory does not operate normally or where the accessory is anomalous or in an anomalous state. The non-normal state is neither the normal state nor the failed state; the non-normal state is a state from which the accessory can return to the normal state. The non-normal state may be also referred to as a transient anomalous state. The accessory in the non-normal state may return from the non-normal state to the normal state with an appropriate return measure conducted or with an elapse of time without any return measure conducted. Further, the factor is to cause the accessory in the normal state to transition from the normal state to the non-normal state; the factor may be also referred to as a cause.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A vehicular self-diagnosis apparatus for a vehicle to diagnose whether an accessory in the vehicle exhibits an anomaly, the apparatus comprising:
a state recording section to record accessory data of the accessory; and
a determination recording section to
determine which state among a normal state, a failed state, and a non-normal state the accessory exhibits based on the accessory data, and
record the determined state.

2. The vehicular self-diagnosis apparatus according to claim 1, further comprising:
a factor storage portion to store at least one factor that causes the accessory to transition from the normal state to the non-normal state; and
an inquiring section to conduct an inquiry based on the factor when the determination recording section determines that the accessory exhibits the non-normal state.

3. The vehicular self-diagnosis apparatus according to claim 2, further comprising:
a return-measure storage portion to store at least one return measure that returns the accessory from the non-normal state to the normal state,
wherein the inquiring section conducts the inquiry about the return measure with respect to the accessory exhibiting the non-normal state.

4. The vehicular self-diagnosis apparatus according to claim 2, further comprising:
a failure determination portion to determine whether the accessory is failed when the determination recording section determines that the accessory exhibits the non-normal state,
the inquiring section conducts the inquiry when the determination recording section determines that the accessory exhibits the non-normal state and, simultaneously, the failure determination portion determines that the accessory is not failed.

5. The vehicular self-diagnosis apparatus according to claim 3,
wherein the inquiring section conducts the inquiry about the at least one return measure in an inquiry order from the return measure providing a highest possibility of returning from the non-normal state to the normal state.

6. The vehicular self-diagnosis apparatus according to claim 3,
wherein the inquiring section conducts the inquiry about the return measure by displaying the return measure using an image or a video.

7. The vehicular self-diagnosis apparatus according to claim 3,
wherein in cases that a response is received following the inquiring section's conducting the inquiry about the return measure, the determination recording section then determines whether the accessory exhibits the normal state or the non-normal state.

8. The vehicular self-diagnosis apparatus according to claim 6,
wherein the inquiring section records a history of an inquiry and a response.

9. The vehicular self-diagnosis apparatus according to claim 6,
wherein in cases that the determination recording section still determines that the accessory exhibits the non-normal state after the response is received for each of all the at least one return measure, the inquiring section recommends an inspection or a repair of the accessory that still exhibits the non-normal state.

10. The vehicular self-diagnosis apparatus according to claim 1,
wherein the accessory is a sensor provided in the vehicle.

11. A method of controlling a vehicular self-diagnosis apparatus for a vehicle to diagnose whether an accessory in the vehicle exhibits an anomaly, the method being executed by a computer using a storage portion, the method comprising:
recording accessory data of the accessory in the storage portion; and
determining which state among a normal state, a failed state, and a non-normal state the accessory exhibits based on the accessory data, and recording the determined state in the storage portion.

12. The method according to claim 11,
wherein the computer further uses a factor storage portion to store at least one factor with respect to the accessory, the factor leading the accessory to the non-normal state,
the method further comprising:
conducting an inquiry based on the factor when it is determined that the accessory exhibits the non-normal state.

13. The method according to claim 12,
wherein the computer further uses a return-measure storage portion to store at least one return measure that returns the accessory from the non-normal state to the normal state, and
wherein the inquiry about the return measure is conducted with respect to the accessory exhibiting the non-normal state.
